(19) United States
(12) Patent Application Publication
(10) Pub. No.: US 2008/0205050 A1
(43) Pub. Date: Aug. 28, 2008

(54) Lighting apparatus

(76) Inventor: Terrick Moyer, St. Petersburg, FL (US)

Correspondence Address: JAMES RAY & ASSOCIATES, 2640 PITCAIRN ROAD, MONROEVILLE, PA, 15146, US

(21) Appl. No.: 12/011,516

(22) Filed: Jan. 28, 2008

Related U.S. Application Data
(60) Provisional application No. 60/886,969, filed on Jan. 29, 2007.

(51) Int. Cl. F21L 4/00

(52) U.S. Cl. 362/183; 362/157

(57) ABSTRACT

An apparatus for use with an electric lamp, such apparatus comprising a housing for storing at least one battery, such housing being manufactured from a first predetermined material and having a first predetermined size and a first predetermined shape and being engageable with a base of such electric lamp. At least one light emitting diode light is disposed on such housing. A circuit mechanism operably connects the at least one battery to such at least one light emitting diode light and a switch mechanism is disposed in the circuit mechanism for selectively opening and closing the circuit mechanism.

### CROSS REFERENCE TO RELATED APPLICATION

This patent application is related to and claims priority from U.S. Provisional Patent Application Ser. No. 60/886,969 filed Jan. 29, 2007.

### FIELD OF THE INVENTION

The present invention relates, in general, to lamps and, more particularly, this invention relates to back-up lighting.

### BACKGROUND OF THE INVENTION

Prior to the conception and development of the present invention, lamps, as are generally well known in the prior art, have been used to provide light in darkened areas and rooms. Conventional lamps are powered by being plugged into a structure's electrical outlets. However, if a power outage occurs, occupants of the structure are left without light. This situation can be annoying, inconvenient, and even frightening and can result in adverse and dangerous situations.

Specifically of interest to the present invention are the following: Furst, U.S. Pat. No. 5,844,328, provides a backup power system for a structural appliance normally operated by a primary source of AC current through a primary circuit. Specifically, this patent is geared toward large appliances such as hot water tanks and furnaces.

Defouw, et al, U.S. Pat. No. 7,036,961, discloses a recessed lighting fixture that includes a battery assembly integrally connected to a recessed enclosure.

Blackman, U.S. Pat. No. 5,473,517 discloses a housing for an emergency light source which is electrically connectable to a conventional light switch.

### SUMMARY OF THE INVENTION

The present invention provides an apparatus for use with an electric lamp. Such apparatus includes a housing for storing at least one battery. Such housing being manufactured from a first predetermined material and having a first predetermined size and a first predetermined shape and being engageable with a base of such electric lamp. At least one light emitting diode light is disposed on such housing. A circuit means operably connects the at least one battery to such at least one light emitting diode light. A switch means is disposed in the circuit means for selectively opening and closing the circuit means.

In another embodiment, a lighting apparatus is provided which includes an electric lamp. A primary source of AC current is connected to such electric lamp through a first circuit such that when such AC current flows to such lamp, such lamp is illuminated. At least one battery is disposed within a base of such lamp. At least one light emitting diode light is disposed on the base of such lamp at a predetermined location thereon. A second circuit means is operably connected to such at least one light emitting diode light for operably connecting the at least one battery to such at least one light emitting diode light. A switch means is interposed in each of the first circuit and the second circuit for selectively opening and closing the first circuit and the second circuit.

### OBJECTS OF THE INVENTION

It is, therefore, one of the primary objects of the present invention to provide a lamp fitted with light emitting diode lights and at least one battery such that the light emitting diode lights can be illuminated when needed to provide light.

Another object of the present invention is to provide a lamp which can be operated from a standard wall outlet and, if a power outage occurs, can be operated at least in part, from battery power.

Still another object of the present invention is to provide a housing which can be retrofitted to existing lamps such that if a power outage occurs, light emitting diodes on such housing can be operated through use of a back-up power source.

Yet another object of the present invention is to provide an aesthetically pleasing light apparatus which can, at least in part, be operated even if a power outage should occur.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which the apparatus includes an electric lamp having at least one light emitting diode light disposed on the base of such lamp.

FIG. 2 is a partial perspective view of the invention according to a one embodiment of the invention in which at least one battery is housed within the base of an electric lamp for supplying power to light emitting diodes disposed on such base.

FIG. 3 is a partial schematic view of the invention according to one embodiment of the invention which includes an electric lamp.

FIG. 4 is a partial perspective view of the invention according to one embodiment of the invention in which the invention is engageable with the base of an electric lamp.

FIG. 5 is a partial perspective view of the invention according to a one embodiment of the invention.

FIG. 6 is a partial schematic view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

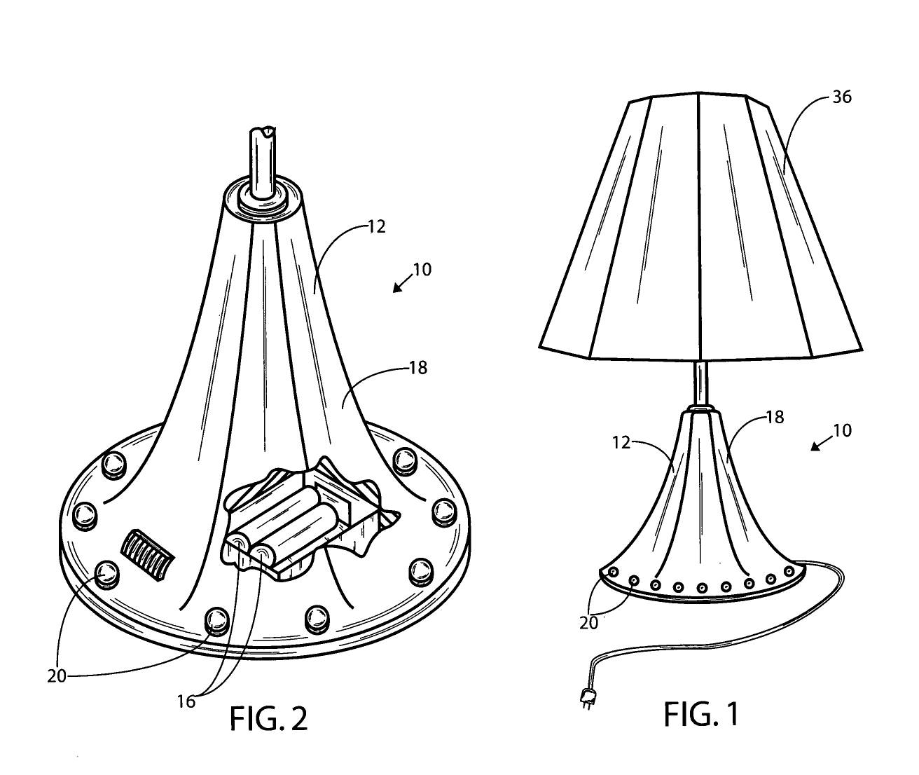

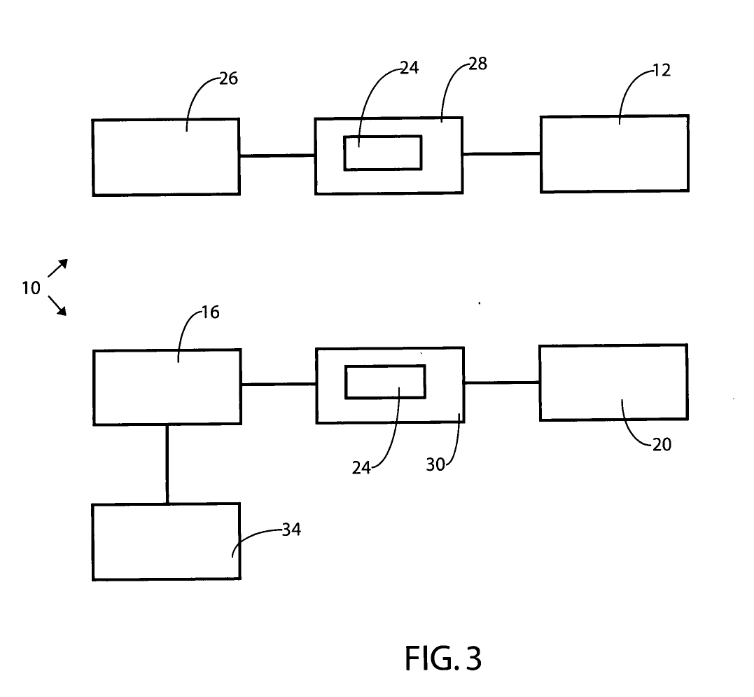

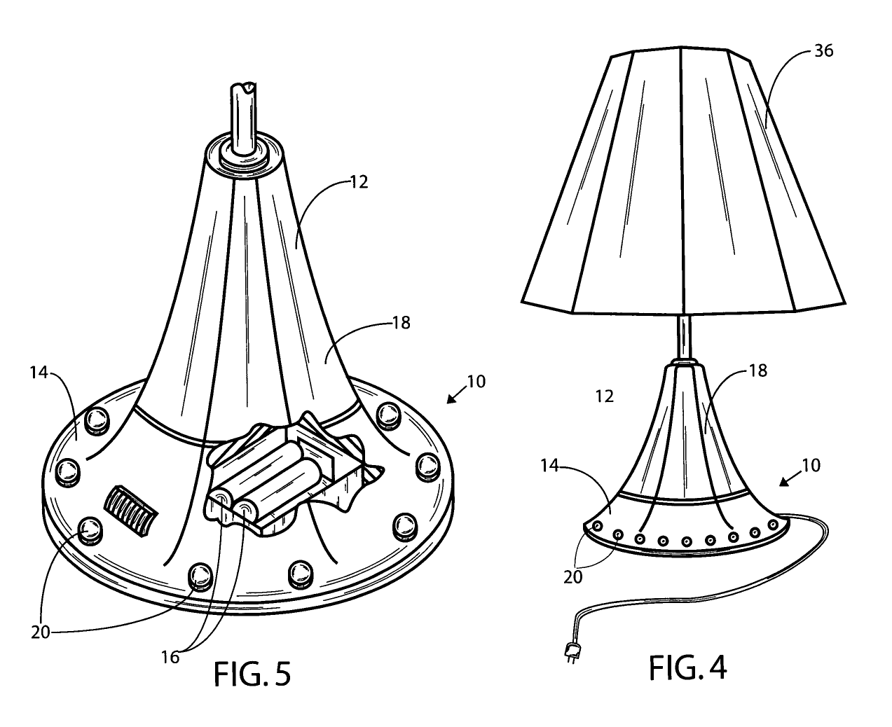

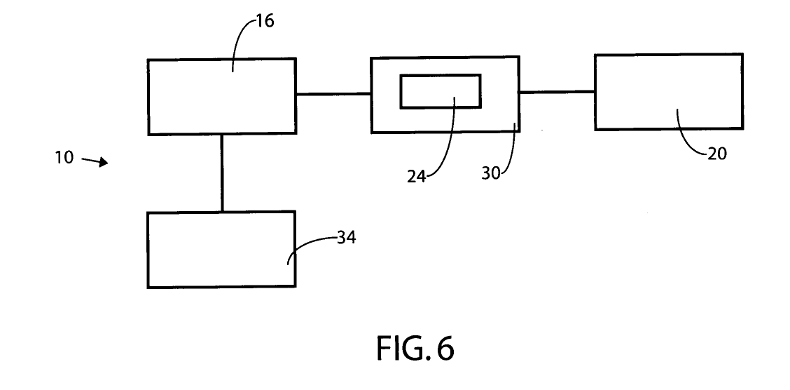

Reference is now made, more particularly, to FIGS. 1-6.

A lighting apparatus, generally designated 10, for use with an electric lamp 12 is provided. Such apparatus includes a housing 14 for storing at least one battery 16, such housing 14 being manufactured from a first predetermined material and having a first predetermined size and a first predetermined shape and being engageable with a base 18 of such electric lamp 12.

At least one light emitting diode light 20 is disposed on such housing 14. A circuit means 22 operably connects the at least one battery 16 to at least one light emitting diode light 20. A switch means 24 is disposed in the circuit means 22 for selectively opening and closing the circuit means 22.

It is presently preferred that such lighting apparatus 10 includes a plurality of light emitting diode lights 20 disposed on the housing 14. It is further presently preferred that such plurality of light emitting diode lights 20 are formed in at least one of a predetermined shape, a predetermined size, and a combination thereof.

It is presently preferred that the at least one battery 16 is rechargeable. It is further presently preferred that such lighting apparatus 10 includes a means 34 for recharging the at least one battery 16.

According to another embodiment, such lighting apparatus 10 includes an electric lamp 12. A primary source of AC current 26 is connected to the electric lamp 12 through a first circuit 28 such that when such AC current flows to the lamp 12, the lamp 12 is illuminated.

At least one battery 16 is disposed within a base 18 of said lamp 12. At least one light emitting diode light 20 is disposed on the base 18 of the lamp 12 at a predetermined location.

A second circuit means 30 is operably connected to the at least one light emitting diode light 20 for operably connecting the at least one battery 16 to the at least one light emitting diode light 20. A switch means 24 is interposed in each of the first circuit 28 and the second circuit 30 for selectively opening and closing the first circuit 28 and the second circuit 30.

It is presently preferred that the at least one battery 16 is rechargeable. It is further presently preferred that such lighting apparatus 10 includes a means 34 for recharging the at least one battery 16.

It is presently preferred that such lighting apparatus 10 includes a plurality of light emitting diode lights 20 disposed on the base 18 of the lamp 12 at predetermined locations thereon. It is further presently preferred that such plurality of light emitting diode lights 20 are formed in at least one of a predetermined shape, a predetermined size, and a combination thereof.

It is presently preferred that such base 18 is formed in at least one of a predetermined shape, a predetermined size and a combination thereof.

It is presently preferred that such electric lamp 12 includes a lamp shade 36. It is further presently preferred that such lamp shade 36 is formed in at least one of a predetermined shape, size and a combination thereof.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A lighting apparatus for use with an electric lamp, said apparatus comprising;
a. a housing for storing at least one battery, said housing being manufactured from a first predetermined material and having a first predetermined size and a first predetermined shape and being engageable with a base of such electric lamp;
b. at least one light emitting diode light disposed on said housing;
c. a circuit means for operably connecting said at least one battery to said at least one light emitting diode light; and
d. a switch means disposed in said circuit means for selectively opening and closing said circuit means.

2. A lighting apparatus according to claim 1 wherein said apparatus includes a plurality of light emitting diode lights disposed on said housing at predetermined locations thereon.

3. A lighting apparatus according to claim 2 wherein said plurality of light emitting diode lights are formed in at least one of a predetermined shape, size, and a combination thereof.

4. A lighting apparatus according to claim 1 wherein said at least one battery is rechargeable.

5. A lighting apparatus according to claim 4 wherein said lighting apparatus further includes a means for recharging said at least one battery.

6. A lighting apparatus comprising;
a. an electric lamp;
b. a primary source of AC current connected to said electric lamp through a first circuit such that when such AC current flows to said lamp, said lamp is illuminated;
c. at least one battery disposed within a base of said lamp;
d. at least one light emitting diode light disposed on said base of said lamp at a predetermined location.
e. a second circuit means operably connected to said at least one light emitting diode light for operably connecting said at least one battery to said at least one light emitting diode light; and
f. a switch means interposed in each of said first circuit and said second circuit for selectively opening and closing said first circuit and said second circuit.

7. A lighting apparatus according to claim 6 wherein said at least one battery is rechargeable.

8. A lighting apparatus according to claim 7 wherein said lighting apparatus further includes a means for recharging said at least one battery.

9. A lighting apparatus according to claim 6 wherein said apparatus includes a plurality of light emitting diode lights disposed on said base of said lamp at predetermined locations thereon.

10. A lighting apparatus according to claim 9 wherein said plurality of light emitting diode lights are formed in at least one of a predetermined shape, a predetermined size, and a combination thereof.

11. A lighting apparatus according to claim 6 wherein said base is formed in at least one of a predetermined of shape, a predetermined size and a combination thereof.

12. A lighting apparatus according to claim 6 wherein said electric lamp includes a lamp shade.

13. A lighting apparatus according to claim 12 wherein said lamp shade is formed in at least one of a predetermined shape, a predetermined size and a combination thereof.
